(19) United States
(12) Patent Application Publication
(10) Pub. No.: US 2009/0150403 A1
(43) Pub. Date: Jun. 11, 2009

(54) Methods and Apparatus for Dynamic Generation and Notification of Virtual Presentities for Presence-Based Awareness

(76) Inventors: William Francis Jerome, Baldwin Place, NY (US); Archan Misra, Bridgewater, NJ (US)

Correspondence Address: RYAN, MASON & LEWIS, LLP, 90 FOREST AVENUE, LOCUST VALLEY, NY, 11560, US

(21) Appl. No.: 11/954,141

(22) Filed: Dec. 11, 2007

(51) Int. Cl. G06F 17/30

(52) U.S. Cl. 707/10; 707/E17.014

(57) ABSTRACT

Techniques for managing entities identified by presence information in a communications network are provided. A condition expressing one or more predicates over one or more presence attributes in the communications network is received. A dynamic entity is generated, wherein the dynamic entity allows at least one user to subscribe thereto. The dynamic entity comprises at least one entity identified by presence information when it is determined that the at least one entity satisfies the condition. The generated dynamic entity is managed by either or both of: (i) adding to the dynamic entity at least another entity identified by presence information that satisfies the condition; and (ii) removing from the dynamic entity an entity identified by presence information that no longer satisfies the condition.

### FIELD OF THE INVENTION

The present invention relates to managing entities identified by presence information (i.e., presentities) in a communications network that includes publishers and subscribers and, more particularly, to techniques for generating and managing a virtual presentity that allows subscribers to search for and subscribe to presentities based on continuous evaluation of predicates over the attributes of the individual presentities.

### BACKGROUND OF THE INVENTION

Presence, broadly defined as the ability of a communications infrastructure to both track and disseminate a variety of dynamic attributes of individuals or objects, is rapidly becoming a key component of converged network applications in both telephone company (telco) provider and enterprise environments. Presence has rapidly evolved from its roots in instant messaging status (e.g., “buddy” status) to become a standard event mechanism for aggregating context about individuals, devices, and abstract entities (e.g., meetings, activities, and location coordinates). Currently, the Session Initiation Protocol for Instant Messaging and Presence Leveraging Extensions (SIP/SIMPLE) based presence architecture has been standardized and is a key component in, for example, the 3rd Generation Partnership Project (3GPP) IP Multimedia Subsystem architecture (IMS). However, the current uses of presence center around explicitly defined subscriptions. For instance, end-points for SIP-based signaling are typically identified by SIP Universal Resource Identifiers (URIs) of the form sip:user@domain and unless a user is aware of the specific URI of a presence entity (or presentity), the user can not obtain a subscription to the presentity. Further, searching for a presentity under the basic presence architecture is equally limited because the user must know specific attributes of the presentity.

Recent innovations have proposed the notion of “rich” or “derived” presence to capture a variety of higher-level, or correlated presence attributes of a presentity. Even with rich presence, the publish-subscribe model of presence remains explicit and a subscriber must still specify the unique SIP-URI of a presentity, as well as specific predefined attributes of the presentity, in order to subscribe. Thus, there is no true search capability available to subscribers of presence.

Therefore, there is a need for a system that allows subscribers to search for and subscribe to presentities using presentity attributes that are not predefined. Moreover, given the long-term nature of subscriptions, a system that can alter the subscription to individual presentities in response to relevant changes in their presentity attributes is needed.

### SUMMARY OF THE INVENTION

Principles of the present invention provide techniques that overcome the above-mentioned drawbacks associated with existing methods by providing techniques that address the above needs, as well as other needs. More particularly, principles of the invention allow subscribers to search for and subscribe to presentities, based on the continual evaluation of predicates over the attributes associated with individual presentities.

In accordance with one aspect of the invention, a technique for managing entities identified by presence information in a communications network is provided. A condition expressing one or more predicates over one or more presence attributes in the communications network is received. A dynamic entity (e.g., a virtual presentity) is generated, wherein the dynamic entity allows at least one user to subscribe thereto. Further, the dynamic entity comprises at least one entity identified by presence information when it is determined that the at least one entity satisfies the condition. The dynamic entity is then managed by one or both of: (i) adding another entity identified by presence information that satisfies the condition; and (ii) removing an entity identified by presence information that no longer satisfies the condition. An entity identified by presence information may represent a human, a device, and/or an automated system.

In an additional embodiment of the present invention, the condition may be related to a location and/or an event involving the entity. Further, the one or more predicates of the condition may be contained in a query. The query may be defined in an Extensible Markup Language (XML)-based query specification. Further still, the query may be appended to a universal resource identifier (URI) of a message within which the condition is contained. And, the query may be contained in a message within which the condition is contained.

In an alternative embodiment of the present invention, the generation of the dynamic entity may involve assigning a universal resource identifier (URI) to the dynamic entity. Further, the generation may also involve correlating the condition with the presence information of the at least one entity identified by presence information using an event correlation engine, wherein the event correlation engine incorporates at least one correlation rule into the dynamic entity.

In an additional alternative embodiment, each of the users subscribed to the dynamic entity can unsubscribe from any entity identified by presence information included in the dynamic entity. Also, users that are subscribed to the dynamic entity may be notified of at least one of: (i) a presence of the at least one entity identified by presence information included in the dynamic entity; (ii) an addition to the dynamic entity of at least another entity identified by presence information that satisfies the condition; and (iii) a removal from the dynamic entity of an entity identified by presence information that no longer satisfies the condition.

In a second aspect of the invention, an article of manufacture for managing entities identified by presence information in a communications network comprises a computer readable storage medium identified by one or more programs which when executed by a computer implement the above steps.

In a third aspect of the invention, an apparatus for managing entities identified by presence information in a communications network comprises: a memory; and at least one processor coupled to the memory and operative to: (i) receive a condition expressing one or more predicates over one or more presence attributes in the communications network; (ii) generate a dynamic entity wherein the dynamic entity allows at least one user to subscribe thereto and further wherein the dynamic entity comprises at least one entity identified by presence information when it is determined that the at least one entity satisfies the condition; and (iii) manage the dynamic entity by at least one of: (a) adding to the dynamic entity at least another entity identified by presence information that satisfies the condition; and (b) removing from the dynamic entity an entity identified by presence information that no longer satisfies the condition.

In a fourth aspect of the present invention, a system for managing entities identified by presence information in a communications network comprising one or more publishers and one or more subscribers is provided. The system comprises at least one presence server operatively coupled to the one or more publishers and the one or more subscribers, the server being operative to: (i) receive a condition expressing one or more predicates over one or more presence attributes in the communications network; (ii) generate a dynamic entity wherein the dynamic entity allows at least one user to subscribe thereto and further wherein the dynamic entity comprises at least one entity identified by presence information when it is determined that the at least one entity satisfies the condition; and (iii) manage the dynamic entity by at least one of: (a) adding to the dynamic entity at least another entity identified by presence information that satisfies the condition; and (b) removing from the dynamic entity an entity identified by presence information that no longer satisfies the condition.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating a methodology for managing presentities in a communications network, according to an embodiment of the present invention;

FIG. 2 is a diagram illustrating a system for managing presentities in a communications network, according to an embodiment of the present invention;

FIG. 3 is a diagram illustrating a virtual presentity, according to an embodiment of the present invention;

FIG. 4 is a flow diagram illustrating a methodology of a presence server for generating a virtual presentity, according to an embodiment of the present invention;

FIG. 5 is a system diagram illustrating a correlation engine and a presence server, according to an embodiment of the present invention;

FIG. 6 is a diagram illustrating the interaction between a watcher, a presence server, a correlation engine, and a presentity, according to an embodiment of the present invention; and

FIG. 7 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

Illustrative embodiments of the present invention will be described below in the context of a presence server that generates virtual presentities wherein subscribers can search for and subscribe to presentities using presentity attributes that are not predefined, however, it is to be understood that principles of this invention are generally applicable to any system that manages virtual presentities and presentities in a communications network.

The term “presentity” as used herein is intended to be construed broadly so as to encompass, by way of example and without limitation, an entity identified by presence information (e.g., a screen name that identifies a human, device, or automated system) and that is associated with a unique identifier (e.g., a URI).

The term “virtual presentity” as used herein is intended to be construed broadly so as to encompass, by way of example and without limitation, a presentity that is created, simulated, or carried on by a computer or computer network, which dynamically represents one or more presentities. A virtual entity is one example of a “dynamic entity.”

A key challenge in managing entities identified by presence information in a communications network is giving a user the ability to search for presentities without predefined limitations. Conventional techniques require that a subscriber specify a unique SIP-URI of a presentity, as well as specific predefined attributes of the presentity, in order to subscribe. Current conventional techniques do not allow an arbitrary search for presentities. For example, a subscriber may wish to subscribe to “conferences with 10 or more active participants,” and thus automatically become cognizant of the current set of conferences satisfying that property, without having prior knowledge of the URI associated with a specific conference presentity. The ability to search for and create presentities without predefined restrictions would greatly enhance presence awareness in a communications environment.

Referring initially to FIG. 1, a flow diagram illustrates a methodology for managing presentities in a communications network, according to an embodiment of the present invention. Methodology 100 begins at step 102 where a condition defining presence is received from a subscriber. This is unlike conventional presence techniques where an explicit URI for a specific publisher is required. In an illustrative embodiment, the subscriber sends a subscription (or query) containing a predicate set describing the conditions that must be met by an arbitrary set of presentities to be considered a valid source for the specific subscription.

On receiving such a “predicate-driven” subscription, a virtual presentity is generated in step 104. A virtual presentity is a dynamically created presence document with a dynamically assigned SIP-URI, such that the presence document for that URI will only contain information (or pointers) about individual presentities whose attributes currently satisfy the predicate set. In an illustrative embodiment, a presence server creates the virtual presentity. After a virtual presentity is established, the presence server returns the URI of the virtual presentity to the subscriber (also known as a watcher). The watcher can now subscribe to the virtual presentity in a conventional fashion because the watcher possesses an explicit URI. Furthermore, other watchers can subscribe to the newly existing virtual presentity.

By subscribing to a virtual presentity, a watcher can automatically obtain notifications about the presence of individual presentities referenced by the virtual presentity. Further, a watcher can automatically obtain notifications about the addition or deletion of individual presentities from the virtual presentity. The watcher can also use the notifications to retrieve specific presence attributes of an individual presentity using conventional subscribe-notify messaging. In this way, we can significantly extend the capabilities of presence-based converged applications by providing end-applications the capability to issue dynamic subscriptions that do not need to explicitly specify specific sources of presence data, but that allow the watcher to dynamically bind to one or more presence sources that satisfy appropriate properties.

In step 106, the virtual presentity is managed. In an illustrative embodiment, the presence server ensures that the individual presentities referenced by the virtual presentity continue to satisfy the conditions described in the predicate set. This includes adding and/or removing individual presentities that satisfy or no longer satisfy the conditions set forth, respectively. In an additional embodiment, the presence information of the virtual presentity is dynamically updated within the presence server using an internal logic (correlation engine) that applies a set of rules over the raw presence data obtained from the individual presentities. The set of rules are then used to determine when each individual presentity becomes or ceases to be a member of the virtual presentity document.

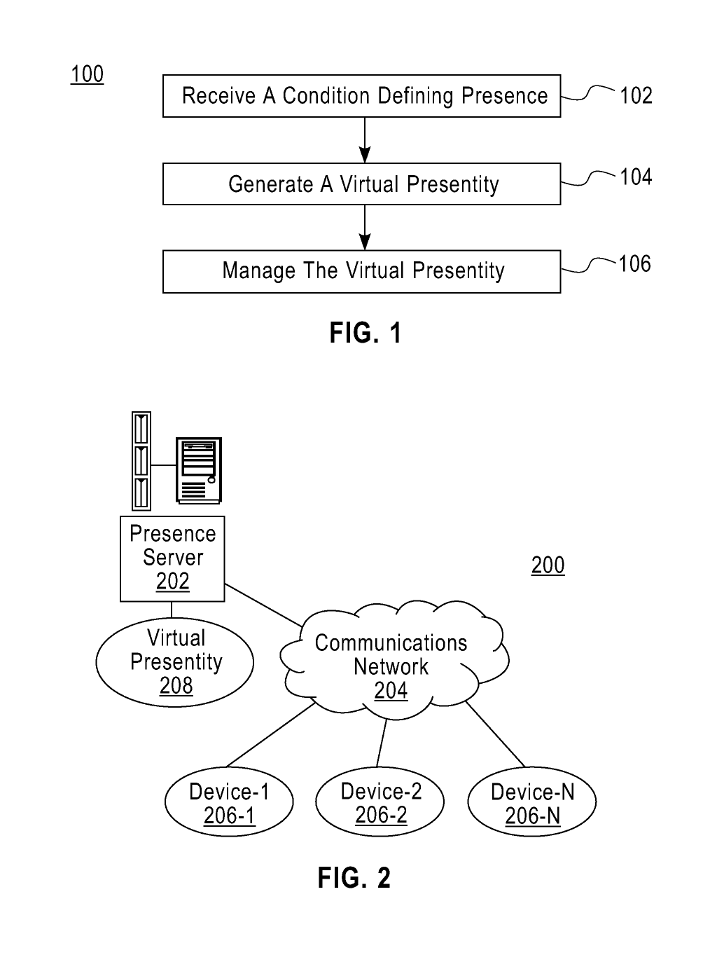

Referring initially to FIG. 2, a diagram illustrates a system for managing presentities in a communications network, according to an embodiment of the present invention. System 200 illustrates an environment in which the methodology of FIG. 1 may be carried out. A presence server 202, is connected to multiple devices (206-1, . . . 206-N) via a communications network 204. The devices may represent a publisher, a presentity, or a watcher. For example, one device may be the personal computer of a watcher who subscribes to locate presentities in a particular geographic area. The watcher sends a subscription specifying geographic location information to the presence server. The presence server then generates a virtual presentity 208 containing individual presentities that satisfy the specified conditions. One presentity, represented by a device, may be a person's cellphone that is transmitting global positioning information that satisfies the specified conditions. In an alternative embodiment, the presence server may update the virtual presentity to include new presentities that satisfy the specified conditions. Further, the presence server may remove presentities that no longer satisfy the specified conditions.

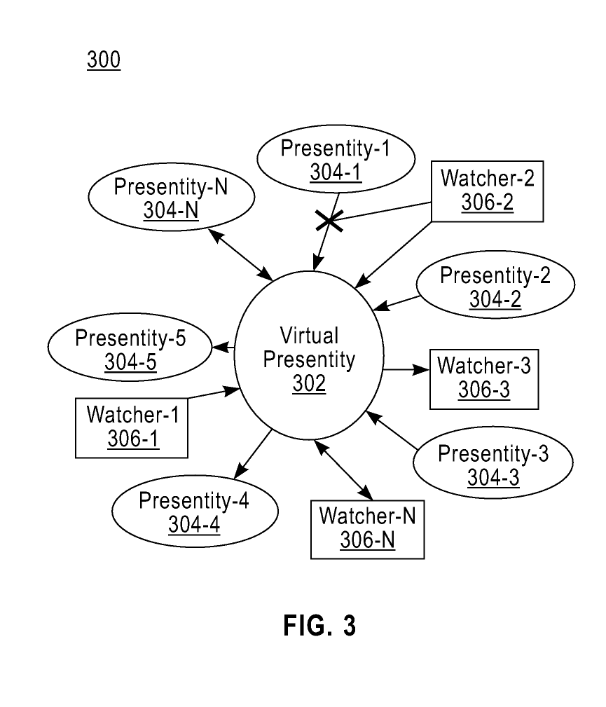

Referring initially to FIG. 3, a diagram illustrates a virtual presentity, according to an embodiment of the present invention. In an illustrative embodiment, a virtual presentity 302 may contain multiple individual presentities (304-1, . . . 304-N) that satisfy the predicate set describing conditions defined by a subscriber. Further, multiple watchers (306-1, . . . 306-N) that subscribe to the same presentity conditions may subscribe to the same virtual presentity as opposed to multiple virtual presentities being generated. This is to prevent redundant generation of virtual presentities that contain the same predicate conditions and individual presentities.

In an illustrative embodiment, the virtual presentity is regularly updated to include only those individual presentities that continue to satisfy the predicate conditions. Individual presentities that no longer satisfy the predicate conditions are removed by the presence server (304-4 and 304-5). Any update to the set of individual presentities that define the membership of the virtual presentity is then communicated to the watchers of the virtual presentity. In an additional illustrative embodiment, watchers can subscribe to the virtual presentity (306-1 and 306-2) or unsubscribe (306-3). Furthermore, a subscribed watcher can unsubscribe from individual presentities (306-2) while remaining subscribed to the virtual presentity.

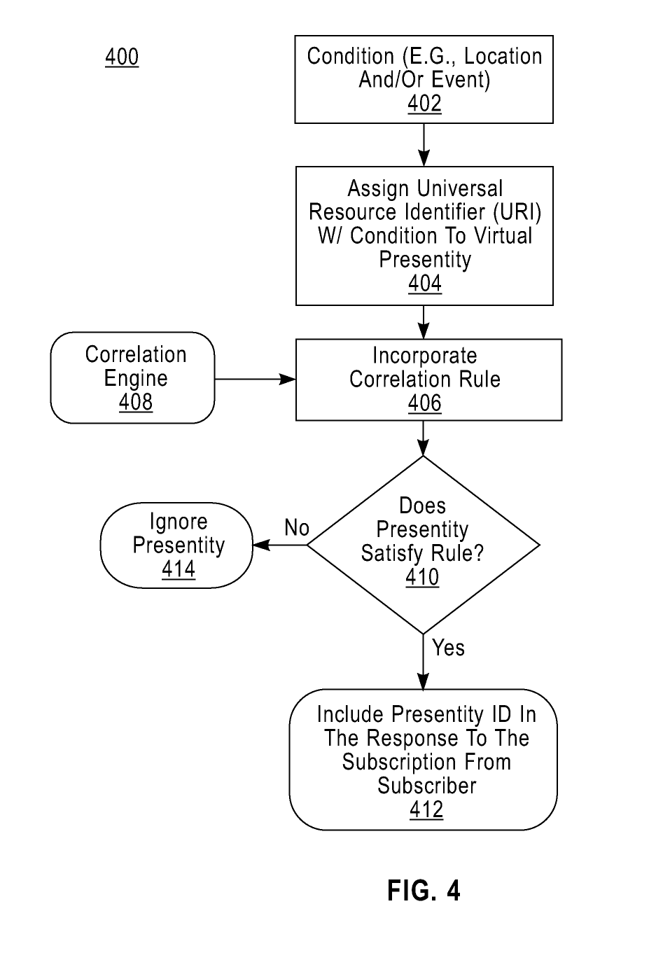

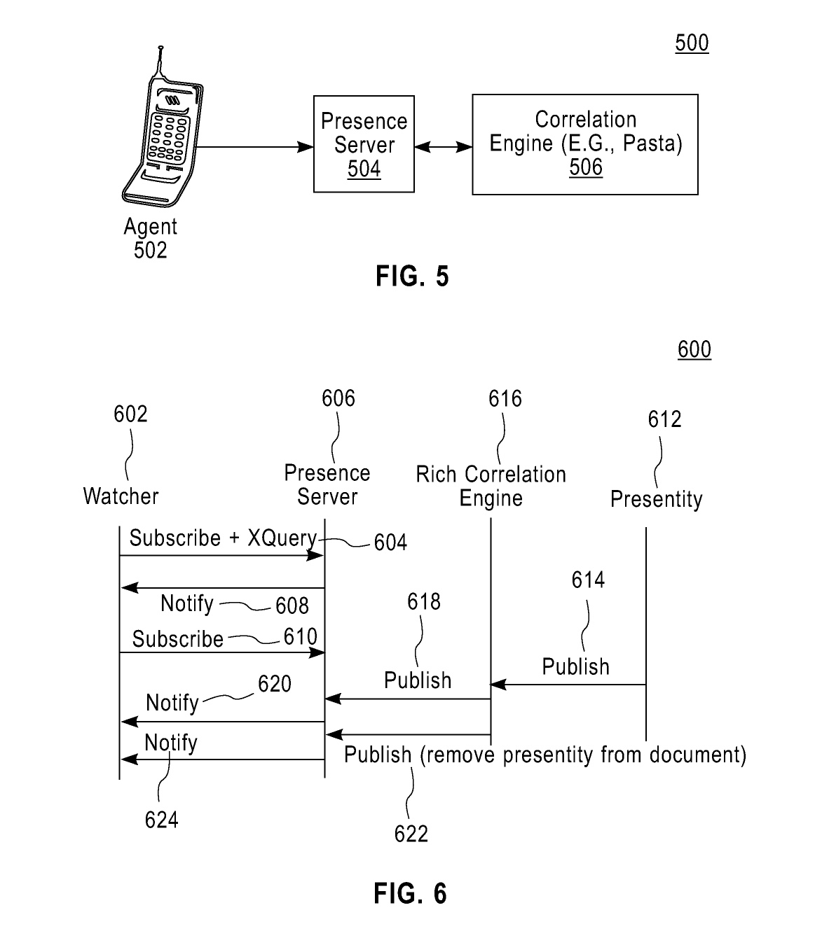

Referring initially to FIG. 4, a flow diagram illustrates a methodology of a presence server for generating a virtual presentity, according to an embodiment of the present invention. Methodology 400 begins at step 402 where a condition, expressed as a set of predicates defined over attributes of an arbitrary set of individual presentities, is defined by a subscriber and communicated to the presence server via a subscriber message. In one embodiment, the condition can be a predicate over the location and/or event presence attributes of the individual presentities. After obtaining a condition, a URI for a virtual presentity is assigned 404. The virtual presentity reflects the condition defined by the subscriber. In an illustrative embodiment, the virtual presentity is incorporated with a correlation rule 406 which is generated by a correlation engine 408. A correlation engine will be described in greater detail in FIG. 5. In general, a correlation engine creates rich presence information from raw presence information.

If an individual presentity satisfies the incorporated correlation rule 410, then the individual presentity is identified and the ID of the presentity is published as part of the response to the original subscription 412. Further, the presentity is included in the virtual presentity. If the individual presentity does not satisfy the correlation rule 410, then the presentity is ignored and not included in the virtual presentity 414.

Referring initially to FIG. 5, a system diagram illustrates a correlation engine and a presence server, according to an embodiment of the present invention. System 500 is a system diagram applying the methodology of FIG. 4. System 500 begins with an agent (an individual presentity) 502 who publishes raw presentity information, such as location information and calendar schedule information, to the presence server 504. The presence server, which maintains a virtual presentity with an assigned URI and conditions defined by a subscriber, takes the presentity information from the agent and determines if the agent satisfies the conditions of the virtual presentity. In this example, the condition defined by a subscriber is any presentity “headed towards meeting.” However, the presentity information published by the agent only contains raw location and calendar schedule information. In an illustrative embodiment, the presence server takes the raw presentity information of the agent and processes it through a correlation engine 506. The correlation engine converts the raw data into rich event information, which is then used to determine if the agent satisfies the conditions of the virtual presentity. In this instance, the correlation engine determines that the raw location and calendar information of the agent shows that the presentity is “headed towards meeting.” The following pseudocode exemplifies a rich, derived attribute generated by a correlation engine:

```
<?xml version=“1.0” encoding=“UTF-8” ?>
  <presence xmlns=“urn:ietf:params:xml:ns:pidf”
xmlns:ext=“urn:ibm:com:tapas” entity=“pres:sip:archan@us.ibm.com”>
  <tuple id=“ACTBusyStatus:bill”>
  <status />
  <timestamp>2006-06-12T17:40:50Z</timestamp>
  <note>TAPAS</note>
  <ext:attribute>
<ext:value type=“string”>Busy</ext:value>
<ext:confidence>1.0</ext:confidence>
<<ext:until>2006-06-12T17:40:55Z</ext:until>
  </ext:attribute>
  </tuple>
  <tuple id=“ActivityStatus:archan@us.ibm.com”>
  <status />
  <timestamp>2006-06-12T17:39:12Z</timestamp>
  <note>TAPAS</note>
  <ext:device-list>
  <ext:value type=“string”>headed towards meeting</ext:value>
<ext:confidence>1.0</ext:confidence>
<ext:source>wlan</ext:source> </ext:attribute>
  </tuple>
  </presence>
```

The correlation engine may be a Presence Advanced Services for Telco Applications (PASTA) system. PASTAs are generally known in the art. See, e.g., E. Belinsky, et al., PASTA: Deriving Rich Presence for Converged Telecommunications Network Applications, IEEE COMSWARE 2007 conference, the disclosure of which is incorporated by reference herein. Correlation engines, such as PASTA, operate on raw presence data in conjunction with a presence server to generate “rich” or “derived” presence states for a presentity. In general, PASTA-like engines have the rule-driven capability to: (a) generate either arbitrary new attributes or modify existing attributes for a pre-defined presentity, or (b) generate new presence states for completely new presentities. In an illustrative embodiment, the rich presentity data generated by a correlation engine may be subsequently used in an attribute-based query mechanism.

Referring initially to FIG. 6, a diagram illustrates the interaction between a watcher, a presence server, a correlation engine, and a presentity, according to an embodiment of the present invention. First, a watcher 602 subscribes to a presence server 606. In an illustrative embodiment, the subscription is a URI representing a well known service on the presence server for creating and managing virtual presentities. Moreover, the subscription also includes an XQuery expression 604, as either an additional set of filters in the URI or as part of the body of the subscription message addressed to the URI. The XQuery expression contains the predicates that indicate the membership criteria for the virtual presentity. The following pseudocode exemplifies a subscription containing an XQuery:

```
SUBSCRIBE sip:virtualpresentity@example.com SIP/2.0
Via: SIP/2.0/TCP watcherhost.example.com;branch=z9hG4bKnashds7
To: <sip:virtualpresentity@example.com>
From: <sip:archan@example.com>;tag=xfg9
Call-ID: 2010@watcherhost.example.com
CSeq: 17766 SUBSCRIBE
Max-Forwards: 70
Event: presence
Accept: application/virtual+xml
Contact: <sip:archan@watcherhost.example.com>
Expires: 600
Content-Length: 30
Xquery: <query>
    {for $b in presence-domain(“example.com/”)
    where $b/[tuple=’location’]” and $b/tuple/location=“office”
    return <room roomid=“{$b/roomid}”> </room> }
</query>
etc.
```

The above sample Xquery requests the return of the URI of those entities (along with their room ID) that currently have their location equal to “office,” implying that the users associated with those presentities are at work.

The presence server then notifies 608 the watcher that the virtual presentity has been generated. The following pseudocode exemplifies a notification containing the SIP-URI of the dynamic virtual presentity:

NOTIFY sip:archan@example.com SIP/2.0 Via: SIP/2.0/TCP
server.example.com;branch=z9hG4bKna998sk
From: <sip:virtualpresentity@domain.com>;tag=ffd2
To: <sip:archan@example.com>;tag=xfg9
Call-ID: 2010@watcherhost.example.com
Event: presence Subscription-State: active;expires=599 Max-Forwards: 70
CSeq: 8775
NOTIFY Contact: sip:server.example.com Content-Type:
application/virtual+xml
Content-Length: 50
VirtualPresentityID: sip:onlinejavaexperts.5X67@example.com

The watcher can then subscribe (step 610) to the virtual presentity. Note that the virtual presentity URI is now viewed as a resource list URI. Techniques for exchanging presence subscriptions with such resource-list URIs are generally known in the art. See A. Roach, et al., “A Session Initiation Protocol (SIP) Event Notification Extension for Resource Lists,” RFC 4662, January 2005 and J. Rosenberg, “Extensible Markup Language (XML) Formats for Representing Resource Lists,” RFC 4826, May 2007, the disclosures of which are incorporated by reference herein. The following pseudocode exemplifies a subscription to the virtual presentity:

SUBSCRIBE sip:onlinejavaexperts.5X67y@example.com SIP/2.0

Via: SIP/2.0/TCP watcherhost.example.com;branch=z9hG4bKnashds7
To: < sip:onlinejavaexperts.5X67y@example.com >
From: <sip:archan@example.com>;tag=xfg9
Call-ID: 2010@watcherhost.example.com
CSeq: 17766 SUBSCRIBE
Max-Forwards: 70
Event: presence
Accept: application/rlmi+xml
Contact: <sip:archan@watcherhost.example.com>
Expires: 600
Content-Length: 30

A presentity 612 is included in the virtual presentity if it satisfies the conditions set forth by the watcher. In an illustrative embodiment, the raw presence information of the presentity is published 614 to a rich correlation engine 616 which processes the raw presence information. The product of the rich correlation engine is rich presence information which is published 618 to the presence server. In this example, the rich presence information satisfies the conditions of the virtual presentity and, therefore, the watcher is notified 620 of the presence of the presentity. The following pseudocode exemplifies a notification that lists the presentities currently online:

NOTIFY sip:archan@watcherhost.example.com SIP/2.0
Via: SIP/2.0/TCP pres.vancouver.example.com;
branch=z9hG4bKMgRenTETmm
Max-Forwards: 70
From: < sip:onlinejavaexperts.5X67y@example.com >;tag=zpNctbZq
To: < sip:archan@example.com >;tag=ie4hbb8t Call-ID:
cdB34qLToC@terminal.vancouver.example.com CSeq: 997935768 N
NOTIFY Contact: < sip:onlinejavaexperts.5X67y@example.com >
Event: presence Subscription-State: active;expires=7200 Require: eventlist
Content-Type: multipart/related;type=“application/rlmi+xml”;
start=“<nXYxAE@pres.vancouver.example.com>”;
boundary=“50UBfW7LSCVLtggUPe5z” Content-Length: 1560 Roach, et
al. Standards Track [Page 20] RFC 4662 SIP Event Lists August 2006 --
50UBfW7LSCVLtggUPe5z Content-Transfer-Encoding: binary Content-
ID: <nXYxAE@pres.vancouver.example.com>
Content-Type: application/rlmi+xml;charset=“UTF-8” <?xml
version=“1.0” encoding=“UTF-8”?>
<list xmlns=“urn:ietf:params:xml:ns:rlmi” uri=“sip:adam-
friends@pres.vancouver.example.com” version=“1” fullState=“true”>
<name xml:lang=“en”>Online Java Experts</name>
<resource uri=“sip:bob@vancouver.example.com””> <name>Bob
Smith</name> <instance id=“juwigmtboe” state=“active”
cid=“bUZBsM@pres.vancouver.example.com”/> </resource>
<resource uri=“sip:dave@vancouver.example.com”> <name>Dave
Jones</name> <instance id=“hqzsuxtfyq” state=“active”
cid=“ZvSvkz@pres.vancouver.example.com”/> </resource>
</list>

If the published presence information of the presentity 622 no longer satisfies the conditions of the virtual presentity, the presence server removes the presentity from the virtual presentity and notifies 624 the watcher.

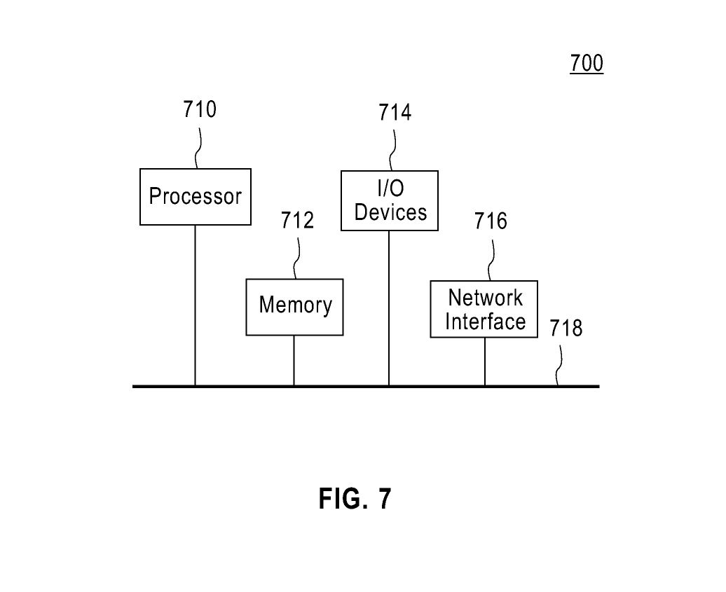

Referring now to FIG. 7, step diagram 700 illustrates an exemplary hardware implementation of a computing system in accordance with which one or more components/methodologies of the invention (e.g., components/methodologies described in the context of FIGS. 1-6) may be implemented, according to an embodiment of the present invention.

As shown, the techniques for managing entities identified by presence information in a communications network may be implemented in accordance with a processor 710, a memory 712, I/O devices 714, and a network interface 716, coupled via a computer bus 718 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for managing entities identified by presence information in a communications network, the method comprising the steps of:
receiving a condition expressing one or more predicates over one or more presence attributes in the communications network;
generating a dynamic entity wherein the dynamic entity allows at least one user to subscribe thereto and further wherein the dynamic entity comprises at least one entity identified by presence information when it is determined that the at least one entity satisfies the condition; and
managing the dynamic entity by at least one of: (i) adding to the dynamic entity at least another entity identified by presence information that satisfies the condition; and (ii) removing from the dynamic entity an entity identified by presence information that no longer satisfies the condition.

2. The method of claim 1, wherein the condition is at least one of a location and an event.

3. The method of claim 1, wherein an entity identified by presence information represents at least one of a human, a device, and an automated system.

4. The method of claim 1, wherein the one or more predicates of the condition are contained in a query.

5. The method of claim 4, wherein the query is appended to a universal resource identifier (URI) of a message within which the condition is contained.

6. The method of claim 4, wherein the query is contained in a message within which the condition is contained.

7. The method of claim 4, wherein the query is defined in an Extensible Markup Language (XML)-based query specification.

8. The method of claim 1, wherein the generating step further comprises the step of assigning a universal resource identifier (URI) to the dynamic entity.

9. The method of claim 1, wherein the generating step further comprises the step of correlating the condition with the presence information of the at least one entity identified by presence information using an event correlation engine, wherein the event correlation engine incorporates at least one correlation rule into the dynamic entity.

10. The method of claim 1, wherein the at least one user has the ability to unsubscribe from any entity identified by presence information included in the dynamic entity.

11. The method of claim 1, further comprising the step of notifying the at least one user subscribed to the dynamic entity at least one of: (i) a presence of the at least one entity identified by presence information included in the dynamic entity; (ii) an addition to the dynamic entity of at least another entity identified by presence information that satisfies the condition; and (iii) a removal from the dynamic entity of an entity identified by presence information that no longer satisfies the condition.

12. An article of manufacture for managing entities identified by presence information in a communications network, the article comprising a computer readable storage medium identified by one or more programs, which when executed by a computer implement the steps of claim 1.

13. An apparatus for managing entities identified by presence information in a communications network, the apparatus comprising:
a memory; and
at least one processor coupled to the memory and operative to: (i) receive a condition expressing one or more predicates over one or more presence attributes in the communications network; (ii) generate a dynamic entity wherein the dynamic entity allows at least one user to subscribe thereto and further wherein the dynamic entity comprises at least one entity identified by presence information when it is determined that the at least one entity satisfies the condition; and (iii) manage the dynamic entity by at least one of: (a) adding to the dynamic entity at least another entity identified by presence information that satisfies the condition; and (b) removing from the dynamic entity an entity identified by presence information that no longer satisfies the condition.

14. The apparatus of claim 13, wherein the condition is at least one of a location and an event.

15. The apparatus of claim 13, wherein the one or more predicates of the condition are contained in a query.

16. The apparatus of claim 13, wherein the operation of generating, the processor is further operative to assign a universal resource identifier (URI) to the dynamic entity.

17. The apparatus of claim 13, wherein the operation of generating, the processor is further operative to correlate the condition with the presence information of the at least one entity identified by presence information using an event correlation engine, wherein the event correlation engine incorporates at least one correlation rule into the dynamic entity.

18. The apparatus of claim 13, wherein the at least one user has the ability to unsubscribe from any entity identified by presence information included in the dynamic entity.

19. The apparatus of claim 13, wherein the processor is further operative to notify the at least one user subscribed to the dynamic entity at least one of: (i) a presence of the at least one entity identified by presence information included in the dynamic entity; (ii) an addition to the dynamic entity of at least another entity identified by presence information that satisfies the condition; and (iii) a removal from the dynamic entity of an entity identified by presence information that no longer satisfies the condition.

20. A system for managing entities identified by presence information in a communications network comprising one or more publishers and one or more subscribers, the system comprising:
at least one presence server operatively coupled to the one or more publishers and the one or more subscribers, the server being operative to: (i) receive a condition expressing one or more predicates over one or more presence attributes in the communications network; (ii) generate a dynamic entity wherein the dynamic entity allows at least one user to subscribe thereto and further wherein the dynamic entity comprises at least one entity identified by presence information when it is determined that the at least one entity satisfies the condition; and (iii) manage the dynamic entity by at least one of: (a) adding to the dynamic entity at least another entity identified by presence information that satisfies the condition; and (b) removing from the dynamic entity an entity identified by presence information that no longer satisfies the condition.
